(19) United States
(12) Patent Application Publication
(10) Pub. No.: US 2004/0201128 A1
(43) Pub. Date: Oct. 14, 2004

(54) Method of increasing output of poly(vinyl chloride) compounds blended from dry-blended powders

(76) Inventors: Peter W. Krause, Grand Valley (CA); Roman B. Hawrylko, Avon Lake, OH (US)

Correspondence Address: John H. Hornickel, PolyOne Corporation, 33587 Walker Road, Avon Lake, OH, 44012, US

(21) Appl. No.: 10/811,571

(22) Filed: Mar. 29, 2004

Related U.S. Application Data
(60) Provisional application No. 60/462,267, filed on Apr. 11, 2003.

(51) Int. Cl. B29C 47/60

(52) U.S. Cl. 264/211.23

(57) ABSTRACT

Dry-blended powders of poly(vinyl chloride) can be extruded as much as 30% faster by replacing a poly(vinyl chloride) powder with another poly(vinyl chloride) powder with an Inherent Viscosity of about 3-35% higher. Unexpectedly, the reduction in bulk density of the product made by the replacement formulation is manageably small, less than about 8%. Poly(vinyl chloride) compounds from such replacement formulations so extruded at such higher speeds can save time, energy, and money for the polymer engineer.

### CLAIM OF PRIORITY

This application claims priority from U.S. Provisional Patent Application Serial No. 60/462,267 bearing Attorney Docket Number 12003009 and filed on Apr. 11, 2003.

### FIELD OF THE INVENTION

This invention relates to extrusion of poly(vinyl chloride)-containing compounds from dry powders, also called a dry blend.

### BACKGROUND OF THE INVENTION

Poly(vinyl chloride) is one of the most versatile and prevalent of all polymers. From the mid-Twentieth Century to the present, the poly(vinyl chloride)-containing compounds have been extruded, calendered, molded, and otherwise formed into a myriad of useful products.

The poly(vinyl chloride) compound often includes more than a single homopolymer having a specific molecular weight or Inherent Viscosity. Other polymers, poly(vinyl chloride) polymers of other Inherent Viscosities, and a wide variety of performance- and process-enhancing additives are included in the vast majority poly(vinyl chloride) compounds. Thus, some form of mixing of these various ingredients is necessary.

Extrusion is a common form of mixing of poly(vinyl chloride) compound ingredients, such that when the compound emerges from the extruder, it can be pelletized or cubed for further processing.

Time is money; energy is money. The cost accounting of the volume of poly(vinyl chloride) compound emerging from an extruder not only includes the cost of the ingredients but also the cost of the manufacturing.

There is a continuous desire to reduce cost and increase productivity of any extrusion process without deleteriously affecting the performance of the product so extruded.

### SUMMARY OF THE INVENTION

There exists a need for increasing output of extrusion of poly(vinyl chloride) compounds, especially compounds prepared from dry blended ingredients, without deleteriously affecting the performance properties of poly(vinyl chloride) compound. More particularly, the need is more acute where the extruder is a high rate twin-screw extruder, an energy-intense polymer processing machine, for production of vinyl profiles, i.e., the final shaped product emerging from the extrusion die.

The present invention solves this problem in the art by using the same equipment as before, but increasing output productivity as much as thirty percent (30%) without reducing bulk density by more than about eight percent (8%).

In other words, the process of the present invention can provide as much as three times as much productivity increase without causing a significant change in resulting product performance properties, such as the profile dimensions, shrinkage, ductility, surface characteristics, etc. This advantage is not insignificant, because the extrusion of a finished profile has much tighter specification tolerances than the extrusion of pellets or cubes that are sent through a second extruder for further processing and article formation. Indeed, while one skilled in the art has tried to boost productivity in the production of cubes and pellets, no one has attempted to do so in the extrusion of profiles, a finished good that has much greater value and is subject to much greater scrutiny under quality control.

It is believed that one skilled in the art would have thought that a mixture of polymeric ingredients for a poly(vinyl chloride) compound having a lower bulk density would also result in a decrease in effective output rate—a loss of productivity.

Unexpectedly and surprisingly, the present invention reveals just the opposite. If all other factors are held constant, a customer who is willing to utilize a poly(vinyl chloride) compound having as little as about eight percent (8%) decrease in bulk density can benefit from the cost savings of having the extruder operate with as much as a thirty percent (30%) increase in productivity.

One aspect of the present invention is (a) selecting a conventional dry blend formulation of poly(vinyl chloride) compound that comprises at least one poly(vinyl chloride) polymer in powder form and additives, (b) replacing, in that conventional dry blend formulation, one poly(vinyl chloride) polymer powder of a given Inherent Viscosity with a replacement poly(vinyl chloride) polymer powder having an Inherent Viscosity from about three percent (3%) to about thirty-five percent (35%) higher to provide a replacement dry blend formulation, and (c) extruding the replacement dry blend formulation through a profile die at a speed of as much as about thirty percent (30%) faster than the extrusion speed for the conventional dry blend formulation.

A feature of the invention is that productivity of existing equipment is enhanced dramatically with a minimal change in resulting product properties.

An advantage of the invention is reduction in both time and energy for a comparable volume of poly(vinyl chloride) compound being extruded.

It is an advantage of the present invention that an extrusion from dry blend into a final extruded product in the form of a profile is more productive without significantly altering product properties.

Further features and advantages will be explained in the following elaboration on embodiments of the invention.

### EMBODIMENTS OF THE INVENTION

Poly(vinyl chloride) Polymer Inherent Viscosities

The useful poly(vinyl chloride) polymers for the present invention can be homopolymers or copolymers of poly(vinyl chloride) commonly available to the polymer industry.

Within the industry, weight average molecular weight and number average molecular weight are more commonly expressed as Inherent Viscosity. While the present invention uses Inherent Viscosity for the comparative nature of the invention, one can also use any of the other bases of measurement, such as Intrinsic Viscosity. The following Table 1 correlates these four systems of measurements of molecular size of the poly(vinyl chloride) polymer, for use in understanding the conventional formulation and the replacement formulation of the present invention.

TABLE 1

| Inherent Viscosity | | Weight Average | Number Average |
|---|---|---|---|
| Cyclohexanone | Intrinsic | Molecular | Molecular |
| 2 gm/100 ml at | Viscosity 1% | Weight | Weight |
| 300° C. | Cyclohexanone | (×10³) | (×10³) |
| 0.92 | 2.19 | 82.5 | 41.0 |
| 0.95 | 2.24 | 86.0 | 42.0 |
| 1.02 | 2.37 | 94.0 | 46.5 |
| 1.06 | 2.44 | 99.0 | 48.5 |
| 1.12 | 2.55 | 106.3 | 51.7 |
| 1.24 | 2.78 | 121.1 | 58.7 |

The method of measurements are well known in the art. Particularly, measurement of Inherent Viscosity is determined by ASTM Method D-1243.

The value in the invention resides in the substitution of a given poly(vinyl chloride) polymer with another poly(vinyl chloride) polymer having an Inherent Viscosity higher than the Inherent Viscosity of the given poly(vinyl chloride) polymer, all other things being the same.

However, one skilled in the art is not limited to only a single replacement. This invention also contemplates the alteration of any other ingredient of the conventional formulation into the replacement formulation.

Also, the invention is not limited to a single poly(vinyl chloride) polymer in the formulation. Often combinations of poly(vinyl chloride) polymers of different molecular sizes exist in conventional formulations.

This invention also contemplates the replacement of more than one of the poly(vinyl chloride) polymers.

Indeed, one skilled in the art, without undue experimentation, can tailor the trade-off of reduction in bulk density with enhancement of extruder productivity in any number of ways.

Notwithstanding these other acceptable variations, the importance and unexpectedness of the invention is best explained with respect to a change of only one poly(vinyl chloride) polymer of the formulation even though the skilled artisan can make other formulation modifications.

For example, it has been found that a conventional formulation, with a single replacement of poly(vinyl chloride) polymer having a higher Inherent Viscosity, can permit increased output speed so important to the cost reduction efforts of the extruder. Table 2 shows the results of one substitution of poly(vinyl chloride) with a higher Inherent Viscosity poly(vinyl chloride).

TABLE 2

| | Inherent | | Increase | Bulk | Decrease |
|---|---|---|---|---|---|
| | Viscosity of | Inherent | in | Density | in Bulk |
| | Poly(vinyl | Viscosity | Extruder | Range | Density |
| Formulation | chloride) | Increase | Speed | (g/cm³) | (Ave.) |
| Conventional | 0.92 | — | — | 0.594- | — |
| | | | | 0.611 | |
| Replacement | 1.02 | 10.8% | 30% | 0.564- | 5.18% |
| | | | | 0.569 | |

Poly(vinyl chloride) polymers are commercially available from OxyVinyls LLC of Houston, Tex., among many other suppliers. Grades of poly(vinyl chloride) are offered by reference to Inherent Viscosity. If not, then Table 1 can provide a cross-reference for appropriate selection of the replacement poly(vinyl chloride) compound.

Particle size for the poly(vinyl chloride) powders can range from about 30 μm to about 400 μm, and preferably from about 100 μm to about 250 μm.

Such replacement permits a dramatic increase in speed of the extruder, although bulk density decreases some. At least the bulk density decrease can become predictable with sufficient replication of the method of the present invention. Thus, one can predict the final bulk density by determining the increase in Inherent Viscosity and the increase in extruder output speed.

As mentioned above, it is believed that one skilled in the art would have expected that a decrease in bulk density in the final polymer, arising from use of a high Inherent Viscosity poly(vinyl chloride) polymer, would also decrease the effective output speed. This belief is based on the following teachings by those skilled in the art that “to increase throughput, it is advantageous to keep the entrained air as low as possible” Hawley et al., “Compaction of Fillers, Flame Retardants and other Additives to Improve Flowability and Accelerate Compounding Rate”, Revised Paper No. 114—Poster Session, Plastics: The Magical Solution. Volume 3: Special Areas ANTEC 2000 [tantamount to linking increased output with increased bulk density.] and “The blends continue to increase in temperature as mixing proceeds, causing agglomeration and an increase in bulk density. This leads to increasing output in, for example, extruders . . . ” Section 12.7.2 “Unplasticized PVC” Plastics Materials (7^{th} Ed.) 1999 [tantamount to linking increased bulk density with increased output].

Also as mentioned above, the conventional formulation can contain other ingredients in the dry blend of polymer powders. Ingredients can optionally include a variety of additives, the details of which are well known to those of ordinary skill in the art.

Non-limiting examples of additives include processing aides, impact modifiers, titanium dioxide, inorganic fillers, pigments, lubricants, organic ultraviolet light screeners, stabilizers, etc. See, e.g., U.S. Pat. No. 5,536,462 (Hawrylko), and U.S. Pat. No. 5,198,170 (Hawrylko), the disclosures of which are incorporated by reference herein.

Extruders for Processing

The invention is not limited by the type of extruder being used to make the resulting poly(vinyl chloride) compound from the dry blend. Extruders can be single screw or twin-screw and single stage or multi-stage. However, it has been found that twin-screw extruders benefit the most from the present invention because such extruders are especially large consumers of energy and are generally slower in output speed.

The use of high output twin extruders is disclosed in U.S. Pat. No. 5,536,462 (Hawrylko), the disclosure of which is incorporated by reference herein. Also, U.S. Pat. No. 5,198,170 (Hawrylko), also incorporated by reference herein, discloses the techniques of using powdered dry blend poly(vinyl chloride) powders in extruders.

Particularly, the present invention is useful with a KMD-90 twin-screw extruder made by Krauss Matter of Florence, Ky., USA. Such extruder has 5 zones and a L/D ratio of 26:1. The means of controlling output speed is based on balancing the revolutions per minute (RPM) of the main extruder screw and the RPM of the feeder screw, as known to those skilled in the art. The exit of polymer from the extruder can proceed through a variety of dies known to those skilled in the art. The product can be extruded into its final profile or co-extruded using specialized dies.

Usefulness of the Invention

The energy savings and attendant time reduction for the practice of the present invention can not be underestimated for a manufacturer facing pricing pressures and the goal of maintaining profit margins for the sale of a product. Without making a new polymer, a poly(vinyl chloride) compound of the replacement formulation by substitution of one grade of poly(vinyl chloride) with another grade of poly(vinyl chloride) can revitalize the economics of vinyl production. For example, one facing full capacity on several twin-screw extruders employing profile dies can avoid the purchase of an additional extruder by using the present invention to increase output of the existing several extruders.

The resulting product is not deleteriously affected by the change in formulation and extrusion processing conditions, if a reduction in bulk density of less than about 8% can be accommodated by the user of the resulting polymer so extruded by the method of the present invention.

The invention is not limited to the above embodiments. The claims follow.

What is claimed is:

1. A method of increasing output of poly(vinyl chloride) compounds blended from dry-blended powders, comprising the steps of:
(a) selecting a conventional dry blend formulation of poly(vinyl chloride) compound that comprises at least one poly(vinyl chloride) polymer in powder form and additives;
(b) replacing, in that conventional dry blend formulation, one poly(vinyl chloride) polymer powder of a given Inherent Viscosity with a replacement poly(vinyl chloride) polymer powder having an Inherent Viscosity about 3 to about 35 percent higher to provide a replacement dry blend formulation; and
(c) extruding the replacement dry blend formulation through a profile die at a speed of as much as about thirty percent (30%) faster than the extrusion speed for the conventional dry blend formulation.

2. The method of claim 1, wherein the poly(vinyl chloride) is a homopolymer or a copolymer.

3. The method of claim 1, wherein the replacement poly(vinyl chloride) polymer powder has an Inherent Viscosity of about 10% higher than the given Inherent Viscosity.

4. The method of claim 1, wherein the replacement poly(vinyl chloride) polymer powder has a particle size of from about 30 μm to about 400 μm.

5. The method of claim 1, wherein the replacement poly(vinyl chloride) polymer powder has a particle size of from about 100 μm to about 250 μm.

6. The method of claim 1, wherein the dry blend formulation further comprises an additive selected from the group consisting of processing aides, impact modifiers, titanium dioxide, inorganic fillers, pigments, lubricants, organic ultraviolet light screeners, and stabilizers.

7. The method of claim 1, wherein extruding step (c) uses a single screw or twin-screw extruder with a single stage or multi-stage configuration.

8. The method of claim 7, wherein the extruder is a twin-screw extruder with 5 zones and a L/D ratio of about 26:1.

9. An article made from dry-blended powder of a poly(vinyl chloride) compound according to the process of claim 1.

10. A use of an extruded article made from dry-blended powder of a poly(vinyl chloride) compound according to the process of claim 1.
